(19) United States
(12) Patent Application Publication
(10) Pub. No.: US 2026/0259750 A1
(43) Pub. Date: Sep. 3, 2026

(54) METHOD FOR INFORMATION PROCESSING AND ELECTGRONIC DEVICES

(71) Applicant: Lenovo (Beijing) Limited, Beijing (CN)

(72) Inventors: Weiwei ZHONG, Beijing (CN); Qiaofen LI, Beijing (CN); Shuiqiang WU, Beijing (CN)

(21) Appl. No.: 19/549,335

(22) Filed: Feb. 25, 2026

(30) Foreign Application Priority Data
Feb. 28, 2025 (CN) 202510239252.8

(51) Int. Cl. G06F 9/451

(52) U.S. Cl. CPC G06F 9/451

(57) ABSTRACT

Method for information processing is provided. The method includes: determining, based on control node information of a target control operation and display interface description information of a display interface, a target node in the display interface that matches the control node information in response to an instruction to perform the target control operation; and simulating, based on control information of the target control operation, a control operation on a target interface element corresponding to the target node in the display interface.

### CROSS-REFERENCE TO RELATED APPLICATION

This application claims priority of Chinese Patent Application No. 2025102392528, filed on Feb. 28, 2025, the entire contents of which are hereby incorporated by reference.

### FIELD OF THE DISCLOSURE

The present disclosure generally relates to the field of information processing technology and, more particularly, relates to a method for information processing.

### BACKGROUND

Although artificial intelligence (AI) technologies continue to develop, task processing often involves content displayed in a display interface of an electronic device. For example, a system may generate a summary describing content of the display interface based on content presented on the electronic device. In another example, in response to a user’s task instruction, the system may plan steps for completing a task indicated by the instruction by combining the content of the display interface of the electronic device with AI services. Accordingly, representing the content displayed in a display interface in a more intuitive manner is crucial for reliably performing related task processing.

### BRIEF SUMMARY OF THE DISCLOSURE

One aspect of the present disclosure provides a method for information processing. The method includes: determining, based on control node information of a target control operation and display interface description information of a display interface, a target node in the display interface that matches the control node information in response to an instruction to perform the target control operation; and simulating, based on control information of the target control operation, a control operation on target interface elements corresponding to target nodes in the display interface.

Another aspect of the present disclosure provides another method for information processing. The method includes: obtaining, in response to an instruction for obtaining display interface description information, a description node tree corresponding to a current display interface, the description node tree including at least one node representing interface elements on the display interface, and hierarchical relationships among different nodes, and different nodes corresponding to different interface elements; generating, based on the hierarchical relationships among the plurality of nodes in the description node tree, interface directory information representing the current display interface by using each node in the description node tree as a directory entry and using node description text of the node as content of the directory entry; and providing the interface directory information.

Another aspect of the present disclosure provides an electronic device. The electronic device includes one or more processors and a memory containing computer programs that, when being executed, cause the one or more processors to perform: determining, based on control node information of a target control operation and display interface description information of a display interface, a target node in the display interface that matches the control node information in response to an instruction to perform the target control operation; and simulating, based on control information of the target control operation, a control operation on target interface elements corresponding to target nodes in the display interface.

Other aspects of the present disclosure can be understood by a person skilled in the art in light of the description, the claims, and the drawings of the present disclosure.

### BRIEF DESCRIPTION OF THE DRAWINGS

The above and other features, advantages, and aspects of embodiments of the present disclosure will become more apparent from the following detailed description with reference to accompanying drawings. Throughout the accompanying drawings, like or similar reference numerals refer to like or similar elements. The accompanying drawings are schematic and that components and elements are not necessarily drawn to scale.

FIG. 1 illustrates a flowchart of an information processing method consistent with various embodiments of the present disclosure.

FIG. 2 illustrates another flowchart of an information processing method consistent with various embodiments of the present disclosure.

FIG. 3 illustrates an example diagram of a display interface consistent with various embodiments of the present disclosure.

FIG. 4 illustrates a flowchart of another information processing method consistent with various embodiments of the present disclosure.

FIG. 5 illustrates a flowchart of another information processing method consistent with various embodiments of the present disclosure.

FIG. 6 illustrates a flowchart of generating operational record information for control operations consistent with various embodiments of the present disclosure.

FIG. 7 illustrates a flowchart of another information processing method consistent with various embodiments of the present disclosure.

FIG. 8 illustrates a flowchart of processing operational instructions based on a knowledge graph consistent with various embodiments of the present disclosure.

FIG. 9 illustrates a schematic diagram of an information processing device consistent with various embodiments of the present disclosure.

FIG. 10 illustrates a schematic diagram of another information processing device consistent with various embodiments of the present disclosure.

FIG. 11 illustrates a schematic diagram of an electronic device consistent with various embodiments of the present disclosure.

### DETAILED DESCRIPTION

The embodiments of the present disclosure are described below with reference to the accompanying drawings. Terminologies used herein are for explaining specific embodiments and are not intended to limit the present disclosure. A person skilled in the art will understand that, as technology evolves and new applications emerge, technical solutions provided herein are also applicable to similar technical problems.

Terms "first," "second," and the like used in the specification, claims, and accompanying drawings of the present disclosure are used to distinguish similar objects and are not necessarily intended to describe a specific order or sequence. It should be understood that these terms, as used herein, may be used interchangeably in appropriate circumstances and are provided merely to distinguish objects having same properties in the embodiments of the present disclosure. Furthermore, terms "comprising" and "having," and any variations thereof, are intended to cover non-exclusive inclusion, so that a process, method, system, product, or device having a series of elements is not limited to the elements but may include other elements not explicitly listed or inherent to the process, method, product, or device.

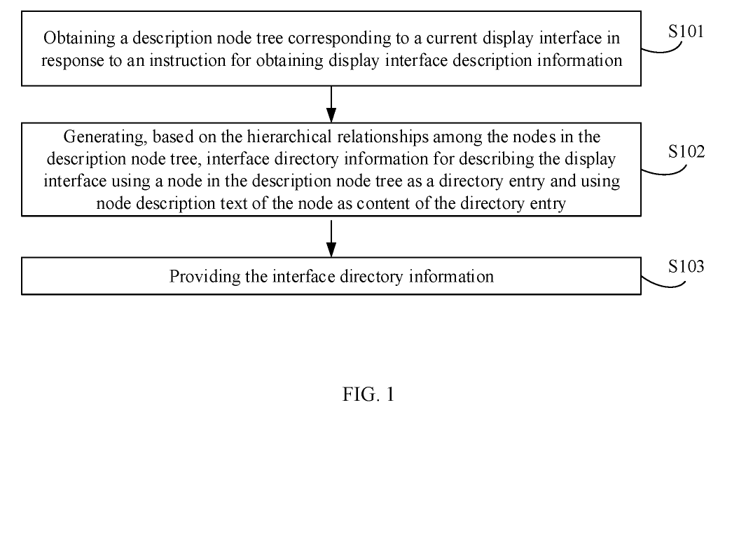

FIG. 1 illustrates a flowchart of an information processing method consistent with various embodiments of the present disclosure. In one embodiment, the method may be applied to electronic devices, such as mobile phones, tablets, or laptops, which are not limited herein. The method in the embodiment may include the following steps.

S101: obtaining a description node tree corresponding to a current display interface in response to an instruction to obtain display interface description information.

The description node tree describes a node tree representing a composition of a current display interface of an electronic device.

The description node tree includes at least one node representing an interface element on a display screen, and hierarchical relationships among the nodes. Different nodes correspond to different interface elements on the display screen.

The interface elements on the display screen are also referred to as user interface (UI) elements. The interface elements may include visible elements displayed on the display screen, such as buttons, input fields, and images, and may also include non-visible elements that support interaction logic, such as listeners or elements used for authentication or permission verification.

The hierarchical relationships among nodes represent relationships among corresponding interface elements.

Each node in the node tree includes attribute information. The attribute information may include a name of an interface element represented by the node and a location of the interface element within the display interface (e.g., coordinates of a corresponding region), among other attributes.

Specifically, the attribute information of a node may further include node description text configured to describe characteristics of an interface element represented by the node. The node description text of a node accurately reflects presentation characteristics of the interface element on the display screen. For example, the node description text may describe a function, a presentation form, and whether the display interface element represented by the node is clickable. Not every node includes node description text, and the node description text of a node may be empty.

As described above, the description node tree is a logical mapping of a current display interface of an electronic device. For example, an operating system may generate a corresponding description node tree in real time based on dynamic changes in the display interface. Accordingly, when content of the display interface of the electronic device is updated, the description node tree may be updated synchronously, so that the description node tree can reflect the composition and content of the current display interface.

For example, in an operating system such as Android, the description node tree may be assistive service node tree (or accessibility tree) that represents a composition of the display interface. Node description text of nodes in the assistive service node tree may provide additional textual descriptions for visually impaired users. The present disclosure may utilize nodes and node description text of the nodes in the assistive service node tree to generate description information about content of the display interface. In other operating systems, or as technology evolves, the description node tree may be implemented in other forms and may be referred to by other names.

Compared with a layout file of a display interface, or an HTML file converted from the layout file, the description node tree can more accurately and intuitively represent the interface elements included in the display interface and the relationships among the interface elements, with reduced redundant information.

S102: generating, based on the hierarchical relationships among the nodes in the description node tree, interface directory information for describing the display interface using a node in the description node tree as a directory entry and using node description text of the node as content of the directory entry.

As can be seen from the implementation for generating the interface directory information, the interface directory information may include at least one directory entry having a hierarchical relationship. Each directory entry represents one node corresponding to the display interface. In one embodiment, the node corresponding to the display interface is a node in the description node tree. Content of each directory entry is node description text of a node corresponding to the directory entry. Accordingly, the hierarchical relationships among directory entries indicate hierarchical relationships among the nodes represented by the directory entries.

Because each node in the node tree represents an interface element in the display interface, each directory entry in the interface directory information corresponds to an interface element of the display interface. Content of the directory entry is featuring description text used to describe characteristics of the interface element corresponding to the directory entry.

To distinguish each directory entry in the interface directory, different directory entries in the interface directory file correspond to different directory entry sequence numbers. Based on the directory entry sequence numbers, in subsequent task processing, a directory entry sequence number may also be used as an index to trace back to a node in the description node tree.

Because the interface directory information describes content of the display interface in a directory format such as a book table of contents or a file directory and does not include images or special syntax such as HTML, the interface directory information may more intuitively and accurately express the content composition of the display interface and has higher readability. Book indexes or file directories are fundamental data for artificial-intelligence applications and training for large language models. Therefore, describing content of a display interface in a directory format reduces difficulty for an AI application or a large language model to understand the interface directory information.

S103: providing the interface directory information.

For example, based on an instruction for obtaining display interface description information, the interface directory information is output, or the interface directory information is provided to an application or a large language model that needs to obtain content of the display interface, without any specific limitations.

As described above, when description information of a display interface needs to be generated, the present disclosure obtains a description node tree of the display interface. Each node in the description node tree is used as a directory entry, and node description text of the node corresponding to the directory entry is used as content of the directory entry, and, in combination with the hierarchical relationships among the nodes in the description node tree, interface directory information for describing the display interface is generated. Because the interface directory information describes the display interface in a directory format, the interface directory information can present the content of the display interface more intuitively and clearly, thereby improving readability. Furthermore, because the description node tree can describe the composition of the display interface and contains relatively little redundant information, the interface directory information generated based on the description node tree may comprehensively represent content of the display interface, thereby facilitating AI applications or models in determining content of the display interface based on the interface directory information and improving accuracy of task processing based on the content of the display interface.

Not every node in the node tree includes node description text. For example, if an interface element represented by a node is an image displayed in the display interface, the node may not include corresponding node description text. However, visible content of the display interface is key information for performing task processing based on the content of the display interface. Therefore, to accurately represent the content of the display interface, before generating the interface directory information, the present disclosure further supplements node description text of certain nodes in the description node tree, so that the node description text of the respective nodes in the description node tree can sufficiently represent the content presented by the display interface.

Specifically, if a node in the description node tree satisfies a target condition, a target interface region in the display interface that is associated with the interface element represented by the node is determined. Based on displayed content within the target interface region, node description text is generated for the node, thereby updating the description node tree.

Specifically, the node satisfying the target condition at least includes that the node does not include node description text for describing the interface element represented by the node.

The target interface region associated with the interface element represented by the node is a region of the interface element in the display interface, such as a display region of the interface element in the display interface or an interface region capable of sensing an input operation. For example, if the interface element is a visible interface element, the target interface region associated with the interface element may be a region covered by the interface element in the display interface. If the interface element is an invisible interface element, the target interface region associated with the interface element may be a region in the display interface in which the interface element can respond to an operation and/or implement display logic control, or the like.

The node description text generated for the node based on the displayed content within the target interface region corresponding to the interface element represented by the node is a description text used to describe the content displayed within the target interface region. Specific implementations of generating the node description text for the node are not limited.

For example, in one possible embodiment, semantic recognition may be performed on the displayed content within the target interface region to determine target semantic information conveyed by the displayed content within the target interface region, and the target semantic information is used as node description text corresponding to a node. For example, a region screenshot of the target interface region in the display interface is obtained, semantic recognition is performed on the region screenshot, and target semantic information conveyed by displayed content of the target interface region is determined.

Generating node description text for a node includes adding the node description text to the node in the description node tree, for example, adding the generated node description text to attribute information of the node.

In the present disclosure, each node in the description node tree may be traversed, and it is determined, for each node in sequence, whether the node satisfies the target condition. When it is determined that a currently traversed node satisfies the target condition, node description text is generated for the node, until all nodes in the description node tree have been traversed, thereby obtaining an updated description node tree.

When the description node tree is updated, the present disclosure generates the interface directory information based on the updated description node tree, as described above and not repeated herein.

Number of nodes in the node tree is relatively large, and interface regions in the display interface corresponding to a plurality of interface elements represented by a plurality of related nodes may overlap. Displayed content in the overlapping interface regions is the same. Therefore, for a plurality of interface elements having overlapping interface regions, it is sufficient to use node description text of a node corresponding to one of the interface elements to represent content of the overlapping region. Accordingly, if node description text is generated for every node in the description node tree that lacks node description text, not only is the data processing volume large, but some processing is unnecessary, thereby causing redundancy among node description texts of different nodes.

In view of the above, in the present disclosure, before generating node description text for a node, it is also necessary to determine whether there is any overlap between the target interface region corresponding to the node and the interface regions corresponding to other nodes that have node description text. A node description text should only be generated for a node if the target interface region corresponding to the node does not overlap the interface regions corresponding to other nodes that already have node description text. Accordingly, the node satisfying the target condition may further include that the target interface region corresponding to the node does not overlap interface regions corresponding to other nodes that include node description text. The interface regions corresponding to the other nodes are regions, in the display interface, of interface elements represented by the other nodes. Details regarding a region of an interface element in the display interface are as described above and are not repeated herein.

On the above basis, considering that a display interface may further include some meaningless or less-meaningful interface elements, the description node tree may include nodes that are not useful for describing the display interface. As number of nodes in the description node tree increases, number of directory entries in the interface directory file also increases. Accordingly, before generating the interface directory information based on the description node tree, the present disclosure may further remove, from the updated description node tree, nodes that satisfy a deletion condition, so as to optimize the description node tree.

The nodes satisfying the deletion condition include at least one of the following: a leaf node that does not include node description text; and a node whose parent node has only the node as a child, the node has only the node as a child, and the node does not include node description text. Accordingly, after the optimized description node tree is obtained, the interface directory information may be generated based on the optimized description node tree.

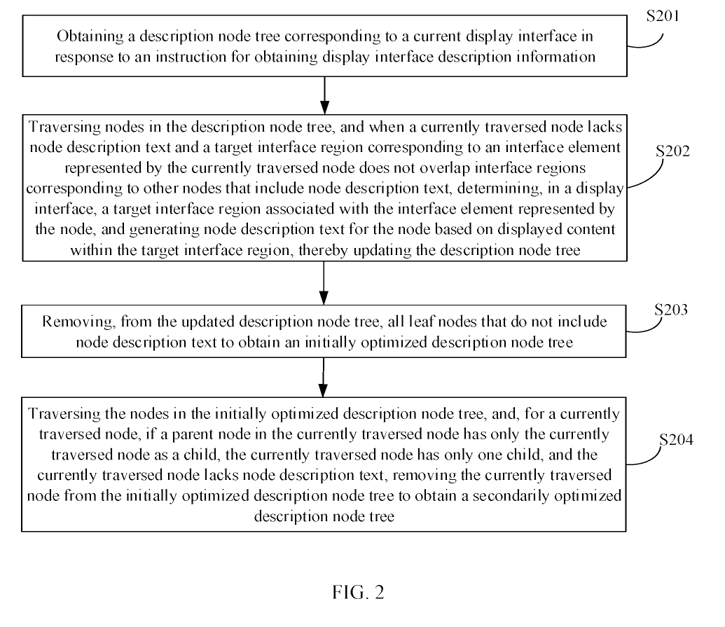

To facilitate understanding of the above process of updating and optimizing the description node tree, a possible implementation is described below with reference to FIG. 2. FIG. 2 illustrates another flowchart of an information processing method consistent with various embodiments of the present disclosure. The method includes the following steps.

S201: obtaining a description node tree corresponding to a current display interface in response to an instruction for obtaining display interface description information.

The description node tree includes at least one node representing interface elements on the display interface and hierarchical relationships among different nodes, where different nodes correspond to different interface elements.

S202: traversing nodes in the description node tree, and when a currently traversed node lacks node description text and a target interface region corresponding to an interface element represented by the currently traversed node does not overlap interface regions corresponding to other nodes that include node description text, determining, in a display interface, a target interface region associated with the interface element represented by the node, and generating node description text for the node based on displayed content within the target interface region, thereby updating the description node tree.

As described above, if interface regions corresponding to different interface elements overlap, description information corresponding to the interface regions is also duplicated. Accordingly, although the node does not include node description text, if other nodes corresponding to other interface elements whose interface regions overlap the interface region corresponding to the interface element represented by the node that includes node description text, node description text is not generated for the node to reduce redundancy among node description texts of different nodes and to reduce data processing volume, and traversal proceeds to a next node in the description node tree.

If the currently traversed node includes node description text, the node may be left unprocessed, and traversal proceeds to a next node in the description node tree.

S203: removing, from the updated description node tree, all leaf nodes that do not include node description text to obtain an initially optimized description node tree.

After processing S202, if a leaf node in the updated description node tree still does not include node description text, the interface element corresponding to the node may be deemed not meaningful for describing content of the display interface. Therefore, to reduce the number of nodes in the description node tree, leaf nodes without node description text may be removed.

S204: traversing the nodes in the initially optimized description node tree, and, for a currently traversed node, if a parent node in the currently traversed node has only the currently traversed node as a child, the currently traversed node has only one child, and the currently traversed node lacks node description text, removing the currently traversed node from the initially optimized description node tree to obtain a secondarily optimized description node tree.

Meaningless nodes in the description node tree can be reduced by S204, thereby reducing a depth and number of nodes in the description node tree.

For example, if a node A has only one child node B, the child node B has only one child node C, and the child node B does not include node description text, then the presence of the child node B is not meaningful. Therefore, the child node B may be deleted from the description node tree, and the child node C may be used as a child node directly connected to the node A.

The nodes in the first-optimized description node tree are traversed in sequence. After traversal of the first-optimized description node tree is completed, nodes to be deleted from the first-optimized description node tree have all been deleted, thereby obtaining a second-optimized description node tree.

S205: using each node in the second-optimized description node tree as a directory entry and using node description text of the node as content of the directory entry, generating, based on hierarchical relationships among the nodes in the second-optimized description node tree, interface directory information for describing the display interface.

S206: providing the interface directory information.

S205 and S206 may refer to the related descriptions in the above embodiments and are not repeated herein. To facilitate understanding of a composition of the interface directory information, one embodiment is described below.

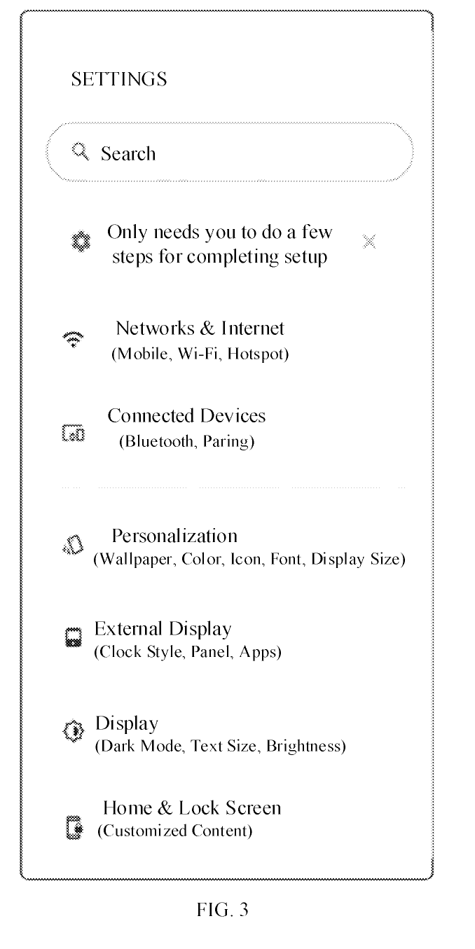

FIG. 3 illustrates an example diagram of a display interface consistent with various embodiments of the present disclosure. In the display interface shown in FIG. 3, an input field, function options, icons, and the like are included.

In the present disclosure, after obtaining the description node tree of the display interface, the description node tree may be updated and optimized according to the embodiment of FIG. 2, and the interface directory information is generated based on the description node tree. For example, the interface directory information generated for the display interface shown in FIG. 3 may be as follows.

(1.1.1) Settings;

(1.1.2.1) An icon representing search or find (e.g., a magnifying glass);

(1.1.2.2) Search settings;

(1.2.1.1.1) An icon representing settings (e.g., options or configuration);

(1.2.1.1.2.1) Complete device setup;

(1.2.1.1.2.2) Just a few more steps;

(1.2.1.1.3) Close;

(1.2.2.1.1) An icon representing network connectivity (e.g., Wi-Fi or signal);

(1.2.2.1.2.1) Network & Internet;

(1.2.2.1.2.2) Mobile, Wi-Fi, and hotspot;

(1.2.2.2.1) An icon representing connected devices (e.g., a phone or smartwatch);

(1.2.2.2.2.1) Connected devices;

(1.2.2.2.2.2) Bluetooth and pairing;

(1.2.2.3.1) An icon representing photos (e.g., an album or camera);

(1.2.2.3.2.1) Personalization;

(1.2.2.3.2.2) Wallpaper, colors, icons, fonts and display size;

(1.2.2.4.1) An icon representing media or audio;

(1.2.2.4.2.1) External display;

(1.2.2.4.2.2) Clock style, panel, and applications;

(1.2.2.5.1) An icon representing brightness or display adjustment;

(1.2.2.5.2.1) Display;

(1.2.2.5.2.2) Dark theme, font size, and brightness;

(1.2.2.6.1) An icon representing security (e.g., a lock);

(1.2.2.6.2.1) Home screen & lock screen;

(1.2.2.6.2.2) Customize what is displayed on the home screen and lock screen.

Numbers in parentheses corresponding to each directory entry above is a sequence number of the directory entry, and relationships among different directory entries can be reflected by the sequence numbers of the directory entries.

For example, (1.1.2.1) and (1.1.2.2) are sequence numbers of two directory entries, and based on these sequence numbers, it can be determined that two nodes corresponding to the two directory entries belong to a same parent node.

For another example, a node corresponding to the directory entry (1.2.2.1.1) and parent nodes in nodes corresponding to the directory entries (1.2.1.1.2.1) and (1.2.1.1.2.2) are at a same hierarchical level. However, the interface directory information above does not include the directory entry (1.2.1.1.2) because a node corresponding to the directory entry (1.2.1.1.2) does not include node description text. Accordingly, when optimizing the description node tree, the node corresponding to the directory entry (1.2.1.1.2) is deleted, and therefore the interface directory information may omit the directory entry (1.2.1.1.2) corresponding to the node.

As can be seen from the display interface shown in FIG. 3, the above directory entries describe the interface elements perceptible to a user in the display interface and textual information presented by the interface elements, thereby sufficiently and intuitively describing the content of the display interface with relatively high readability.

Scenarios of performing related task processing based on the interface directory information of the display interface are described below.

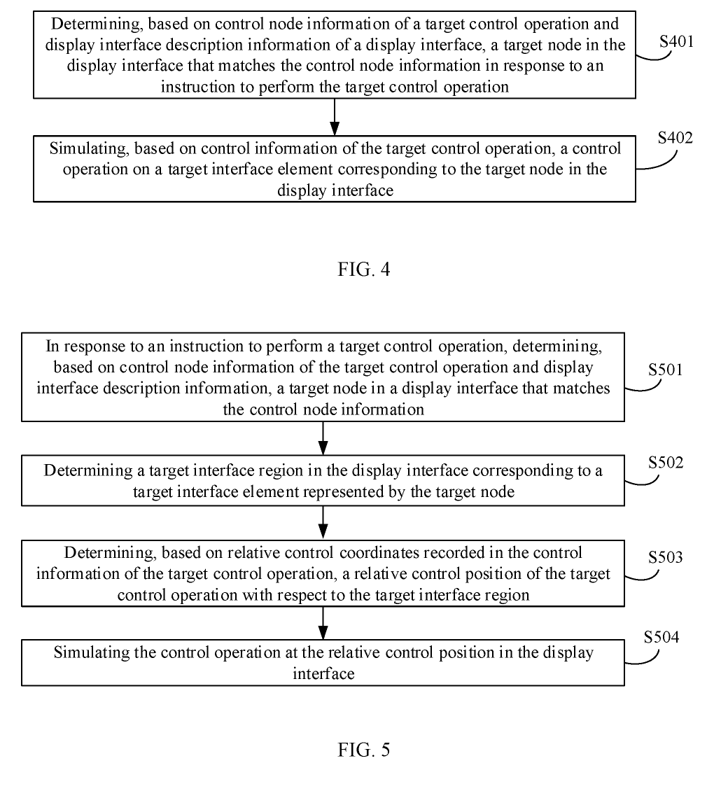

FIG. 4 illustrates a flowchart of another information processing method consistent with various embodiments of the present disclosure. In one embodiment, the method includes the following steps.

S401: in response to an instruction to perform a target control operation, determining, based on control node information of the target control operation and display interface description information of a display interface, a target node in the display interface that matches the control node information.

A target control operation is a previously received control operation. For example, the target control operation is a control operation input by a user and recorded prior to a current time. Accordingly, the target control operation may belong to recorded historical control operations. For example, the target control operation is a recorded control operation that can be replayed (or simulated).

Control node information of the target control operation is used to characterize node features of a historical node corresponding to the target control operation. A historical node corresponding to the target control operation is a node, in a historical display interface in which the target control operation occurred, that is targeted by the target control operation. The historical display interface where the target control operation occurs is also referred to as a historical display interface corresponding to the target control operation, i.e., a display interface that generated the target control operation. To distinguish the display interface corresponding to the target historical operation from a current display interface and nodes corresponding to the current display interface, the display interface corresponding to the target historical operation is referred to herein as a historical operation interface.

In the present disclosure, for either the historical display interface or the current display interface, a node in the display interface represents an interface element of that display interface. For example, the node may be a node in the description node tree of the display interface or may be a node determined based on a layout file of the display interface to represent an interface element, and specific implementations are not limited herein.

Because a historical node corresponds to a display interface element in the historical display interface, characteristics of the historical node correspond to characteristics of the interface element represented by the historical node. For example, the characteristics of a historical node may include node description text of the historical node, which describes characteristics of an interface element represented by the historical node. Typically, the node description text of the historical node includes at least user-perceptible characteristics of the interface element represented by the historical node, such as a presentation form, a function, and an operable state of the interface element.

The display interface description information of the display interface is the interface directory information of the display interface. The interface directory information includes a plurality of directory entries, each corresponding to a node in the display interface. Content of each directory entry is node description text of a node corresponding to the directory entry.

In one embodiment, the interface directory information can be generated based on nodes and hierarchical relationships among nodes in the description node tree of the display interface. Details are described in the foregoing embodiments and are not repeated herein.

In another embodiment, the interface directory information can also be generated based on hierarchical relationships among interface elements in the display interface, as represented in a layout file of the display interface or an HTML file generated from the layout file. In the embodiment, a node corresponding to a directory entry also represents an interface element, and content of the directory entry is node description text of the node representing the interface element. The node description text is used to describe characteristics of the interface element represented by the node.

The interface directory information of the display interface describes content of the display interface in a directory format, thereby more intuitively and clearly presenting the content of the display interface with higher readability and further facilitating more efficient information matching and analysis processing.

The target node is a node in the display interface that matches control node information of a target control operation. Display interface description information of the display interface is the interface directory information of the display interface in which each directory entry corresponds to a node in the display interface and content of each directory entry is node description text of the corresponding node. Accordingly, the target node is a node whose node description text matches the control node information of the target control operation.

For example, when the control node information of the target control operation includes node description text of a historical node corresponding to the target control operation, the target node is a node in the display interface whose node description text matches the node description text corresponding to the target control operation.

S402: simulating, based on control information of the target control operation, a control operation on a target interface element corresponding to the target node in the display interface.

The control information of the target control operation is used to characterize control behavior information of that target control operation. For example, the control information includes at least control position information and may further include control pressure information and information identifying a user performing the control.

Because the target node is, in the current display interface, a node corresponding to the historical node operated by the target control operation, simulating, based on the control information of the target control operation, a control operation on the target interface element represented by the target node can simulate the target control operation in the current display interface, thereby achieving a purpose of replaying the target control operation.

As can be seen from the embodiment, in response to an instruction to perform a target control operation, the present disclosure determines, based on display interface description information of a display interface, a target node in the display interface that matches the control node information of the target control operation. The display interface description information is interface directory information in which each directory entry corresponds to a node in the display interface and content of each directory entry is node description text of the corresponding node. Therefore, because the interface directory information of the display interface can intuitively and clearly describe content of the display interface, a target node matching the control node information of the target control operation can be more accurately and efficiently matched based on the display interface description information of the display interface. Accordingly, based on the control information of the target control operation, a control operation can be accurately simulated on a target interface element represented by the target node, thereby achieving more accurate simulation of the control operation.

Because certain interface elements in the display interface may be correlated or similar, node description text for nodes corresponding to the interface elements may also be similar. Accordingly, control node information derived from the target control operation may match a plurality of target nodes, but not all the matched target nodes are necessarily actual nodes involved in the target control operation.

Based on the above, in the present disclosure, information of the target control operation further includes operation interface description information, which is display interface description information of the historical display interface corresponding to the target control operation. The operation interface description information can be the interface directory information of the historical display interface corresponding to the target control operation. The interface directory information of the historical display interface includes a plurality of historical directory entries, where each historical directory entry corresponds to a node in the display interface and content of each historical directory entry is node description text of the corresponding node. For ease of distinction, nodes in the historical display interface are referred to as historical nodes, and each historical node corresponds to an interface element in the historical display interface.

In one embodiment, for ease of distinction, directory entries in the interface directory information of the historical display interface are referred to as historical directory entries.

If, based on the display interface description information of the display interface, a unique node is identified in the display interface whose node description text corresponding to a directory entry matches the control node information of the target control operation, the unique node is determined as the target node.

Accordingly, if, based on the display interface description information of the display interface, a plurality of candidate nodes in the display interface are determined in the display interface whose node description text corresponding to a directory entry matches the control node information of the target control operation, a target node having a highest matching degree with the control node information may further be determined from the plurality of candidate nodes based on operation interface description information of the target control operation.

Determining the target node from the candidate nodes based on the operation-interface description information may include determining, based on node description text of historical directory entries in the operation interface description information, a target historical directory entry that matches the control node information of the target control operation. Based on node description text of at least one associated directory entry associated with the target historical directory entry in the operation interface description information, and node description text of at least one associated node associated with a candidate node, a target node matching the target historical directory entry is determined from the candidate nodes.

For example, a target historical directory entry that matches control node information of a target control operation is a historical directory entry whose corresponding node description text matches node description text in the control node information.

Directory entries associated with the target historical directory entry may include at least one of: an upper-level directory entry corresponding to the target historical directory entry (i.e., a parent directory entry of the target historical directory entry), a lower-level directory entry of the target historical directory entry, a sibling directory entry that shares the upper-level directory entry of the target historical directory entry and is at a same hierarchical level as the target historical directory entry, and a sibling directory entry that shares a same parent directory entry as the upper-level directory entry of the target historical directory entry and is at a same hierarchical level as the upper-level directory entry of the target historical directory entry.

Similarly, nodes associated with the candidate node may include at least one of: a parent node in the candidate node, a child node in the candidate node, a sibling node in the candidate node, and a sibling node in the parent node in the candidate node.

When determining the target node, a candidate node whose associated node description text has a highest matching degree with node description text of an associated directory entry may be selected as the target node.

For example, according to a priority order of associated directory entries and associated nodes, a current target associated directory entry to be matched may be determined from the associated directory entries of the target historical directory entry, and, for each candidate node, a target associated node to be matched may be determined from associated nodes in the candidate node. If there exists a unique target associated node whose node description text has a highest matching degree with node description text of a target associated directory entry, a candidate node corresponding to the unique target associated node is determined as the target node. If there are a plurality of target associated nodes whose node description text has a highest matching degree with node description text of the target associated directory entry, according to priorities of the associated directory entries and associated nodes, a next target associated directory entry to be matched and a next target associated node in each candidate node are determined and compared until the target node is determined.

Priorities of the associated directory entries, in descending order, may be a lower-level directory entry corresponding to the target historical directory entry, an upper-level directory entry corresponding to the target historical directory entry, a sibling directory entry of the target historical directory entry, and a sibling directory entry of the upper-level directory entry corresponding to the target historical directory entry. Similarly, priorities of associated nodes in a candidate node, in descending order, may be a child node in the candidate node, a parent node in the candidate node, a sibling node in the candidate node, and a sibling node in the parent node in the candidate node.

Alternatively, a priority order may be set according to actual needs and is not limited herein.

In the present disclosure, simulating a control operation on a target interface element corresponding to a target node based on control information of a target control operation may be implemented in various ways. An example implementation is described below.

FIG. 5 illustrates a flowchart of another information processing method consistent with various embodiments of the present disclosure. In one embodiment, the method includes the following steps.

S501: in response to an instruction to perform a target control operation, determining, based on control node information of the target control operation and display interface description information, a target node in a display interface that matches the control node information.

The display interface description information is interface directory information. Each directory entry in the interface directory information corresponds to a node in the display interface, and content of each directory entry is node description text of the corresponding node. Details of S501 may refer to the related descriptions in the previous embodiments and are not repeated herein.

In one embodiment, the control node information of the target control operation may include node description text of a historical node operated by the target control operation in a historical display interface. Accordingly, based on the interface directory information of the display interface, a target directory entry whose corresponding node description text matches the node description text in the control node information of the target control operation may be determined from the interface directory information of the display interface, and a node in the display interface corresponding to the target directory entry is determined as the target node.

A main interface of an electronic device and an application interface of an application in the electronic device (or an application interface implementing a specific service) may undergo code refactoring. The refactoring may cause changes in hierarchical relationships among interface elements in a display interface, and/or changes in parameters such as a display size or a resolution of the display interface. Code refactoring of the display interface is invisible to a user. However, to ensure user experience, changes in visual effects of the display interface are not significant. Accordingly, if, when the target control operation occurs, related parameters such as a name of the interface element operated by the target control operation are recorded, once refactoring or the like occurs, it may be impossible to accurately determine, from an updated display interface, the interface element originally operated by the target control operation, thereby affecting simulation of the target control operation.

In the present disclosure, considering that changes in the visible portion of the display interface occur with a relatively low probability, node description text of a historical node corresponding to a target control operation is recorded when the target control operation occurs. Because node description text can describe visible features of an interface element represented by a node, such as a presentation form and a visible functional effect, even if code of the display interface subsequently changes, the present disclosure can, based on the node description text recorded in the control node information of the target control operation, determine, from an updated display interface, visible features of an interface element represented by a node that the target control operation is intended to operate, thereby accurately locating a target node corresponding to an interface element to be operated in the display interface.

S502: determining a target interface region in the display interface corresponding to a target interface element represented by the target node.

For ease of distinction, an interface region associated with a target interface element represented by a target node is referred to as the target interface region. Description of an interface region associated with an interface element may refer to the previous related descriptions and is not repeated herein.

S503: determining, based on relative control coordinates recorded in the control information of the target control operation, a relative control position of the target control operation with respect to the target interface region.

The relative control coordinates in the control information are relative coordinate positions of a control position of the target control operation on the historical display interface with respect to an interface region associated with a historical node corresponding to the target control operation. Herein, the historical display interface is a display interface in which the target control operation occurred, and the interface region associated with the historical node corresponding to the target control operation is, in the historical display interface, an interface region corresponding to an interface element represented by the historical node.

Because the target node is a node, in the current display interface, that matches the control node information of the target control operation, the relative control coordinates in the control information are relative coordinate positions with respect to the target interface region associated with the target interface element represented by the target node. Accordingly, based on the relative control coordinates, the present disclosure can determine a relative control position of the target control operation on the current display interface with respect to the target interface region.

Because a display interface of an application or a service may be updated, interface regions corresponding to interface elements may also change at different times. Accordingly, if only an operation position point of a touch operation in the display interface is recorded, after the display interface is updated, a function triggered or an action performed based on the operation position point of the touch operation may differ from a function historically triggered or an action historically performed by the touch operation or may even fail to trigger action execution. As a result, the touch operation cannot be simulated (or replayed) on the updated display interface.

In the present disclosure, control information of the target control operation records relative control coordinates of the target control operation with respect to an interface region associated with a historical node corresponding to the target control operation. Accordingly, even if the display interface changes such that a position range of an interface region associated with the historical node corresponding to the target control operation changes, after a node in the display interface corresponding to the target control operation is determined, the relative control coordinates can still be used to accurately determine a relative control position of the target control operation with respect to the target interface region, thereby accurately determining an operation position point at which the target control operation is to be performed in the display interface, and accordingly enabling more accurate simulation of the corresponding control operation.

S504: simulating the control operation at the relative control position in the display interface.

Depending on an operation type of the target control operation, quantities of control node information and control information corresponding to the target control operation may vary. However, processing of each set of control node information and control information is the same. Accordingly, for each set of control node information and control information, a corresponding relative control position can be obtained. Therefore, simulating touch operations at the respective relative control positions can replay the target control operation.

For example, if the target control operation is a click operation, the click operation has one position point. Accordingly, the click operation corresponds to node description text of one historical node and one relative control coordinate, thereby determining one relative control position.

For another example, if the target control operation is a sliding operation, an electronic device may continuously collect control positions during the sliding operation. Accordingly, for each control position during the sliding operation, node description text of a historical node and a relative control coordinate are recorded. Accordingly, when simulating the target control operation, the solution of the present application determines a plurality of consecutive relative control positions, and control operations may be simulated sequentially at the plurality of relative control positions, thereby simulating the sliding operation.

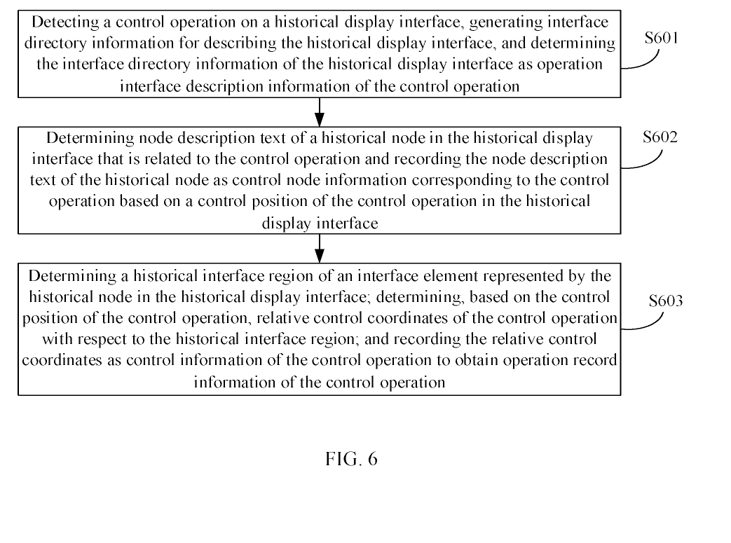

Before receiving an instruction to perform a target control operation, the present disclosure records operation record information of the target control operation when detecting the target control operation. The operation record information includes control node information, control information, and operation-interface description information corresponding to the target control operation. An example implementation is described below. FIG. 6 illustrates a flowchart of generating operational record information for control operations consistent with various embodiments of the present disclosure. The process may include the following steps.

S601: detecting a control operation on a historical display interface, generating interface directory information for describing the historical display interface, and determining the interface directory information of the historical display interface as operation interface description information of the control operation.

For ease of distinction, a display interface before receiving an instruction to perform a target control operation is referred to as a historical display interface.

Specific implementations of generating the interface directory information of the historical display interface may adopt any of the implementations described above for generating the display interface description information of the display interface and are not repeated herein.

In one embodiment, the interface directory information of the historical display interface may be generated using techniques for generating interface directory information described in the embodiments of FIGS. 1 and 2. For example, a description node tree for describing the historical display interface is obtained. Based on hierarchical relationships among nodes in the description node tree of the historical display interface, interface directory information for describing the historical display interface is generated.

Before generating the interface directory information, the description node tree of the historical display interface may also be updated and optimized according to previous implementations for updating and optimizing a description node tree, as described above and not repeated herein.

S602: determining node description text of a historical node in the historical display interface that is related to the control operation and recording the node description text of the historical node as control node information corresponding to the control operation based on a control position of the control operation in the historical display interface.

In the present disclosure, to enable accurate determination, even when code and layout of the historical display interface are subsequently updated or changed, of a display object actually operated by the target control operation, the present disclosure records node description text of a historical node related to the control operation, so that the display object actually operated by the control operation can later be located using the node description text of the historical node. A display object is a user-perceptible object displayed on the display interface, such as text, an image, a button, or a visible region of an interface element in the display interface.

The historical node corresponding to the control operation is a node corresponding to an interface element whose corresponding interface region covers the control position of the control operation. The node description text of the historical node is at least used to describe visible features of the interface element corresponding to the historical node and may also be used to describe other attribute information of the interface element, without limitation.

Specifically, when the interface directory information for the historical display interface is generated based on the description node tree of the historical display interface, the historical node is a node, in the description node tree of the historical display interface, that is related to the interface element corresponding to the control position of the control operation and that includes node description text.

A historical node related to the interface element corresponding to the control operation may belong to a candidate historical node in the description node tree of the historical display interface that describes the interface element corresponding to the control operation, and a parent node, a child node, and a sibling node related to the candidate historical node.

For example, if a candidate historical node corresponding to an interface element that matches the control position of the control operation in the description node tree of the historical display interface includes node description text, the candidate historical node is determined as the historical node operated by the control operation (or the historical node corresponding to the control operation). If the candidate historical node does not include node description text, a parent node, a child node, and a sibling node in the candidate historical node are determined from the description node tree of the historical display interface, and, according to a priority order of child node, parent node, and sibling node, a node having node description text and having a highest priority among the parent node, the child node, and the sibling node in the candidate historical node is determined as the historical node operated by the control operation.

S603: determining a historical interface region of an interface element represented by the historical node in the historical display interface; determining, based on the control position of the control operation, relative control coordinates of the control operation with respect to the historical interface region; and recording the relative control coordinates as control information of the control operation to obtain operation record information of the control operation.

If the control operation is a continuous operation, such as a double-click operation or a sliding operation, a plurality of control positions of the control operation in the historical display interface may be obtained according to a set sampling interval. For each control position, S602 and S603 are performed to obtain interface directory information of the historical display interface corresponding to the control operation, node description text of at least one historical node, and at least one relative control coordinate.

The operation record information generated using the solution of the present disclosure, information such as interface directory entries of the historical display interface and node description text of nodes operated by the control operation is recorded in text form, which is more conducive to understanding by an AI service or a large language model, thereby facilitating the AI service or the large language model learning from the operation record information of the control operation and deriving other control operation information similar to the recorded control operation.

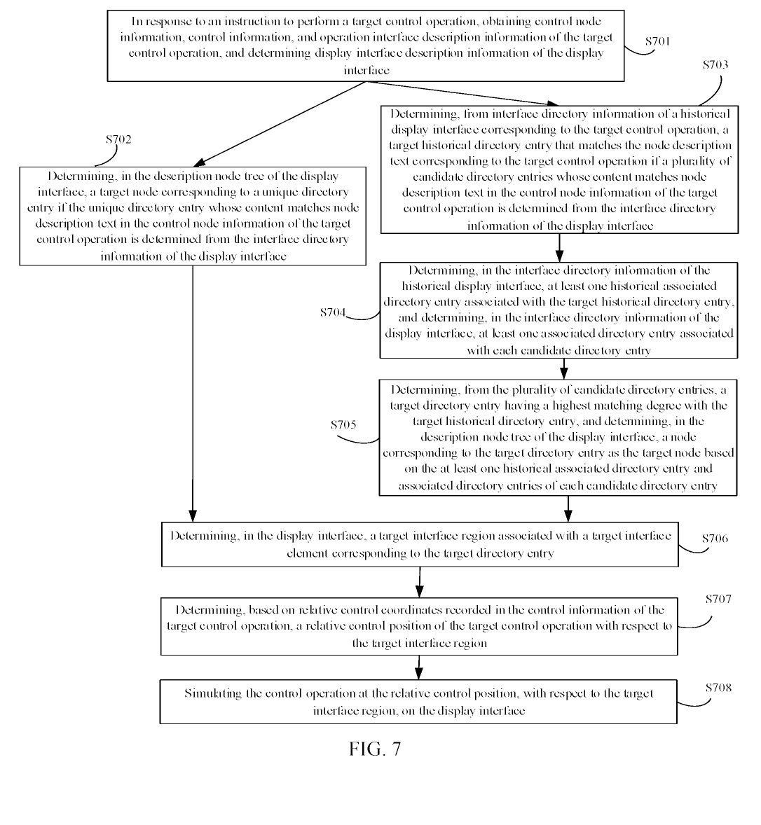

To facilitate understanding of a specific implementation for simulating the target control operation, an example is described below in which display interface description information of the display interface is interface directory information generated based on the description node tree of the display interface. FIG. 7 illustrates a flowchart of another information processing method consistent with various embodiments of the present disclosure. In one embodiment, the method may include the following steps.

S701: in response to an instruction to perform a target control operation, obtaining control node information, control information, and operation interface description information of the target control operation, and determining display interface description information of the display interface.

The control node information includes node description text of a historical node corresponding to the target control operation, and the control information includes relative control coordinates of the target control operation. The relative control coordinates are relative coordinate positions of the target control operation with respect to an interface region corresponding to an interface element represented by the historical node.

The operation interface description information is interface directory information of a historical operation interface corresponding to the target control operation.

The display interface description information of the display interface is the interface directory information corresponding to the display interface. The interface directory information includes a plurality of directory entries, each entry corresponds to a node in the display interface, and content of each directory entry includes node description text of the corresponding node. Specific implementations of determining the interface directory information of the display interface may refer to the related descriptions of the embodiments of FIGS. 1 and 2 above and are not repeated herein.

S702: determining, in the description node tree of the display interface, a target node corresponding to a unique directory entry if the unique directory entry whose content matches node description text in the control node information of the target control operation is determined from the interface directory information of the display interface.

S703: determining, from interface directory information of a historical display interface corresponding to the target control operation, a target historical directory entry that matches the node description text corresponding to the target control operation if a plurality of candidate directory entries whose content matches node description text in the control node information of the target control operation is determined from the interface directory information of the display interface.

S704: determining, in the interface directory information of the historical display interface, at least one historical associated directory entry associated with the target historical directory entry, and determining, in the interface directory information of the display interface, at least one associated directory entry associated with each candidate directory entry.

S705: determining, from the plurality of candidate directory entries, a target directory entry having a highest matching degree with the target historical directory entry, and determining, in the description node tree of the display interface, a node corresponding to the target directory entry as the target node based on the at least one historical associated directory entry and associated directory entries of each candidate directory entry.

Specific implementations of determining the target directory entry from the plurality of candidate directory entries may refer to the related descriptions in the previous embodiments and are not repeated herein.

S706: determining, in the display interface, a target interface region associated with a target interface element corresponding to the target directory entry.

Based on the target node corresponding to the target directory entry, a target interface element represented by the target node can be determined, and accordingly a target interface region in the display interface corresponding to the target interface element can be determined.

S707: determining, based on relative control coordinates recorded in the control information of the target control operation, a relative control position of the target control operation with respect to the target interface region.

S708: simulating the control operation at the relative control position, with respect to the target interface region, on the display interface.

To enable an AI service to operate an application on an electronic device or to perform at least one operation related to implementing a function according to a user instruction, a user generally needs to input a plurality of control operations to demonstrate operation steps for implementing a corresponding operation requirement. Accordingly, in the present disclosure, the target control operation may belong to a control operation in a historically input operation sequence.

For example, in one embodiment, the present disclosure may, in response to an instruction to perform an operation sequence, determine a target control operation to be currently simulated in the operation sequence. Based on the control node information of the target control operation and display interface description information of the display interface, a target node in the display interface that matches the control node information is determined. The operation sequence includes a plurality of control operations, and the target control operation is one of the plurality of control operations.

Furthermore, the present disclosure may store simulated operation sequences in a set of operation sequences. In response to an operation instruction input by a user, an operation sequence matching the operation instruction may be determined from the recorded operation-sequence set, and then a target control operation to be currently simulated is determined from the operation sequence.

The operation instruction input by a user indicates actions to be performed. For example, the operation instruction input by a user may indicate sending a message to a specific user using an instant-messaging application, ordering food using a food-ordering application, sending an email, scheduling a meeting, or the like. User input manners include, but are not limited to, touch input on a display screen, voice input, gesture input, and the like.

For example, In the present application, intent recognition may be performed on an operation instruction input by a user to determine an operation intent of the operation instruction, and whether an operation sequence matching the operation intent exists in the set of operation sequences can be detected.

The operation sequence in the set of operation sequences is an operation sequence previously input by a user. If an operation behavior required by the operation instruction input by a user is not implementable by the current operation sequence, an operation sequence cannot be matched from the set of operation sequences. Accordingly, to respond to the operation instruction input by a user and complete a corresponding operation, the present disclosure may further pre-construct a knowledge graph.

The knowledge graph includes relationships among a plurality of entity nodes. An entity node represents an operation interface or a controllable functional element in the operation interface. The functional element may be a button, an icon, a function option, or the like.

For an entity node in the knowledge graph that represents an operation interface, each entity-node link path starting from the entity node and formed by successively connecting the entity node to other entity nodes constitutes an operation-path link. Each operation-path link is used to indicate an operation path required to implement a service function, and each operation path corresponds to an operation sequence. Different operation-path links correspond to different service functions.

In practical applications, because different applications can implement different types of services, in the present disclosure, different knowledge graphs may be configured for different applications. Based on a knowledge graph corresponding to an application, an operation-path link required to perform a service function using the application can be determined.

For example, in an instant messaging application, the application may implement different functions, and operation steps required to implement a same function on different interfaces of the instant-messaging application may also differ. Accordingly, the knowledge graph may include entity nodes corresponding to different operation interfaces in the instant-messaging application. In addition, functional elements such as icons or buttons to be clicked to implement a function under each operation interface may differ. Accordingly, the knowledge graph may further include entity nodes corresponding to different functional elements. Further, to implement different functions under each operation interface, relationships between an entity node corresponding to an operation interface and entity nodes corresponding to other operation interfaces or functional elements may also be constructed in the knowledge graph.

For example, taking sending a message using an instant messaging application as an example, specific operations for implementing the service function on different interfaces of the instant messaging application may differ. For example, to send a message based on a main interface of the instant-messaging application, it is first necessary to enter the “main interface,” then click a “contacts” option to enter a contacts interface, then input a target contact in a “search box” of the contacts interface, click an avatar icon of the “target contact,” and then, after entering a conversation interface of the target contact, input a message to be sent in a message input field of the conversation interface, and finally click a “send” option in the conversation interface to complete message sending. Accordingly, the knowledge graph includes a plurality of entity nodes such as the main interface, a “contacts” icon, and a search box in the “contacts” interface. The plurality of entity nodes forms an entity-node link path, i.e., main interface → “contacts” icon → “search box” in the contacts interface → “target contact” avatar →message input field in the conversation interface → “send”. The entity-node link path indicates an operation path for sending a message to the “target contact”.

Accordingly, if no operation sequence matching the operation instruction exists in the set of operation sequences, the present disclosure further construct an operation sequence corresponding to the operation instruction based on the knowledge graph. After the operation sequence is constructed, the operation sequence may be performed.

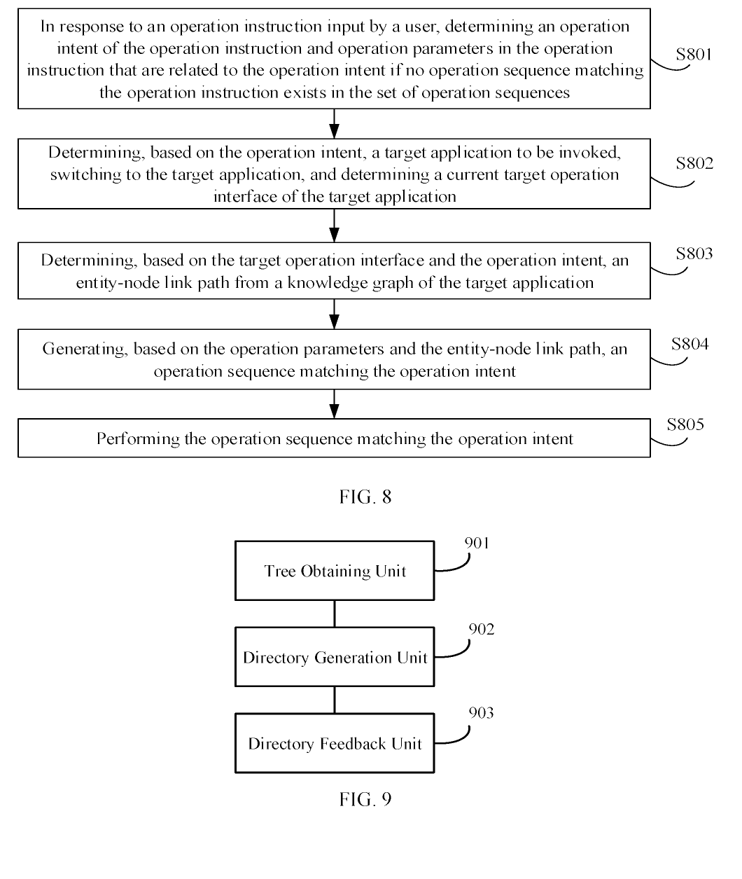

For ease of understanding, one embodiment of processing the operation instruction based on the knowledge graph is described below. FIG. 8 illustrates a flowchart of processing operation instructions based on a knowledge graph consistent with various embodiments of the present disclosure. The embodiment may include the following steps.

S801: in response to an operation instruction input by a user, determining an operation intent of the operation instruction and operation parameters in the operation instruction that are related to the operation intent if no operation sequence matching the operation instruction exists in the set of operation sequences.

For example, the operation parameters are parameters included in the operation instruction that are required to implement an operation corresponding to the operation intent. For example, if the operation instruction is “send a message to Xiaoming telling him to meet at the school gate at 2:00 p.m.”, the operation intent is sending an instant-messaging message. The operation parameters include a recipient “Xiaoming” and message content “meet at the school gate at 2:00 p.m.”.

S802: determining, based on the operation intent, a target application to be invoked, switching to the target application, and determining a current target operation interface of the target application.

Determining which operation interface that the target application is currently in may be implemented using the large language model or another model. To more efficiently determine which operation interface the target application is currently in, the present disclosure may obtain interface directory entries of the current target operation interface of the target application using a manner described in the previous embodiments, and determine a type of the target operation interface such as a main interface, a conversation interface, or the like based on the interface directory entries.

S803: determining, based on the target operation interface and the operation intent, an entity-node link path from a knowledge graph of the target application.

For example, a target entity node is matched in the knowledge graph of the target application based on the target operation interface, and the entity-node link path that starts from the target entity node and can implement the operation intent is determined. A starting node in the entity-node link path is the target entity node, and a last entity node in the entity-node link path is a node matching the operation intent.

Continuing with the above example of sending a WeChat message to Xiaoming, assuming that the target operation interface is a main interface of the target application, an entity node corresponding to the “main interface” is first identified in the knowledge graph. Among entity-node relationship paths connected to the entity node corresponding to the “main interface,” an entity node corresponding to “send” (or “send message,” etc.) is searched, and a shortest entity-node link path from the entity node corresponding to the “main interface” to the entity node corresponding to “send” is determined.

S804: generating, based on the operation parameters and the entity-node link path, an operation sequence matching the operation intent.

For example, from the shortest entity-node link path between “main interface” and “send,” each entity node after the main interface in the entity-node link path may be sequentially determined as an operation to be performed in the operation sequence. If an entity node involves entering a parameter, a corresponding operation parameter may be filled into an operation corresponding to the entity node. For example, if the operation sequence sequentially includes: “contacts” icon → “search box” in the contacts interface → “target contact” avatar →message input field in the conversation interface → “send”, in the operation of the “search box” in the contacts interface, a contact to be searched, i.e., “Xiaoming,” is entered, thereby obtaining an operation of searching “Xiaoming” in the search box. In the operation of the message input field in the conversation interface, “meet at the school gate at 2:00 p.m.” is entered, thereby inputting “meet at the school gate at 2:00 p.m.” in the message input field.

S805: performing the operation sequence matching the operation intent.

For example, the operation sequence may be performed sequentially with assistance of a large language model, and implementations are not limited herein.

Corresponding to an information processing method provided in the present disclosure, an information processing device is further provided in one embodiment. FIG. 9 illustrates a schematic diagram of an information processing device consistent with various embodiments of the present disclosure. In the embodiment, the device may include: A tree obtaining unit 901, configured to, in response to an instruction for obtaining display interface description information, obtain a description node tree corresponding to a current display interface, where the description node tree includes at least one node for representing interface elements on the display interface and hierarchical relationships among different nodes, and different nodes correspond to different interface elements; a directory generation unit 902, configured to use each node in the description node tree as a directory entry and use node description text of the node as content of the directory entry, and generate, based on the hierarchical relationships among the nodes in the description node tree, interface directory information for describing the display interface; and a directory feedback unit 903, configured to provide the interface directory information.

In one embodiment, the device further includes a tree update unit, configured to, before the directory generation unit generates the interface directory information, if a node in the description node tree satisfies a target condition, determine, in the display interface, a target interface region associated with an interface element represented by the node, and generate node description text for the node based on displayed content within the target interface region to update the description node tree.

The node satisfying the target condition includes that the node does not include node description text used to describe the interface element represented by the node.

In another embodiment, in the tree updating unit, the node satisfying the target condition may further include that a target interface region corresponding to the node does not overlap interface regions corresponding to other nodes that include node description text. The interface regions corresponding to the other nodes are regions, in the display interface, of interface elements represented by the other nodes.

In another embodiment, the information processing device further includes a node deletion unit, configured to, before the directory generation unit generates the interface directory information, remove nodes satisfying a deletion condition from an updated description node tree. The nodes satisfying the deletion condition include at least one of: a leaf nodes that does not include node description text; and a node whose parent node has only one child node (the node), the node has only one child node, and the node does not include node description text.

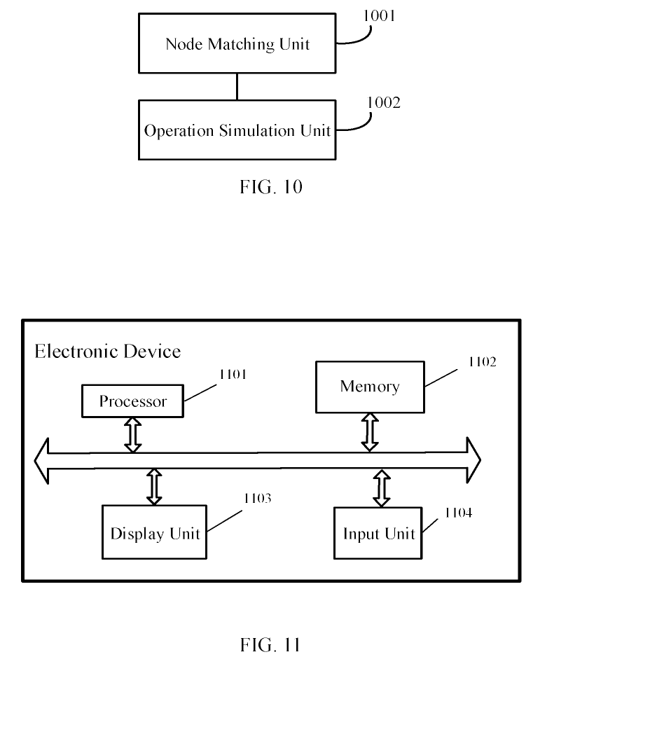

Furthermore, corresponding to the other information processing method provided by the present disclosure, an additional information processing device is also provided in one embodiment. FIG. 10 illustrates a schematic diagram of another information processing device consistent with various embodiments of the present disclosure. In the embodiment, the device may include: a node matching unit 1001, configured to, in response to an instruction to perform a target control operation, determine, based on control node information of the target control operation and display interface description information of a display interface, a target node in the display interface that matches the control node information, where the display interface description information is interface directory information, each directory entry in the interface directory information corresponds to a node in the display interface, and content of the directory entry is node description text of the node corresponding to the directory entry; and an operation simulation unit 1002, configured to simulate, based on control information of the target control operation, a control operation on a target interface element corresponding to the target node in the display interface.

In one embodiment, the operation simulation unit includes: a region determination sub-unit, configured to determine, in the display interface, a target interface region associated with a target interface element represented by the target node; a position determination sub-unit, configured to determine, based on relative control coordinates recorded in control information of the target control operation, a relative control position of the target control operation with respect to the target interface region; and a control simulation sub-unit, configured to simulate the control operation at the relative control position in the display interface.

In another embodiment, the node matching unit includes: a first matching sub-unit configured to, in response to an instruction to perform a target control operation, determine a unique node in the display interface as a target node when, based on display interface description information of the display interface, the unique node is identified whose node description text corresponding to a directory entry matches control node information of the target control operation; and a second matching sub-unit configured to, when, based on the display interface description information, a plurality of candidate nodes are identified in the display interface whose node description texts corresponding to directory entries match the control node information of the target control operation, determine, from the plurality of candidate nodes, a target node having a highest matching degree with the control node information based on operation interface description information of the target control operation.

In another embodiment, the node matching unit, when responding to the instruction to perform the target control operation, is specifically configured to respond to an instruction to perform an operation sequence, and determine a target control operation to be currently simulated in the operation sequence, wherein the operation sequence includes a plurality of control operations, and the target control operation is one of the plurality of control operations.

In another embodiment, the node matching unit, when responding to the instruction to perform the operation sequence, is specifically configured to respond to an operation instruction input by a user, and determine, from a recorded set of operation sequences, an operation sequence matching the operation instruction.

In another embodiment, the device further includes a sequence construction unit configured to, when no operation sequence matching the operation instruction exists in the operation-sequence set, construct an operation sequence corresponding to the operation instruction based on a knowledge graph. The knowledge graph includes relationships among a plurality of entity nodes, and an entity node represents an operation interface or a controllable functional element in the operation interface.

In one embodiment, an electronic device is provided. FIG. 11 illustrates a schematic diagram of the electronic device consistent with various embodiments of the present disclosure. The electronic device includes at least a processor 1101 and a memory 1102. The processor 1101 is configured to perform the information processing methods described according to any one of the embodiments described above. The memory 1102 is configured to store programs required for operations performed by the processor 1101.

In one embodiment, the electronic device further includes a display unit 1103 and an input unit 1104.

The electronic device may include more or fewer components than components shown in FIG. 11 without limitation.

The present disclosure further provides a computer program product including computer-readable instructions that, when performed by an electronic device, cause the electronic device to perform any of the information processing methods described in the embodiments of the present disclosure.

The present disclosure further provides a computer-readable storage medium storing one or more computer programs that, when performed by an electronic device, cause the electronic device to perform any of the implement processing methods described in the embodiments of the present disclosure.

It should also be noted that the device embodiments described above are merely illustrative. Units described as separate components may or may not be physically separate, and components shown as units may or may not be physical units. That is, the units may be in one place or may be distributed among a plurality of network units. Some or all of the modules may be selected according to actual needs to achieve objectives of the embodiments. In addition, in the accompanying drawings illustrating the device embodiments of the present disclosure, connection relationships between modules indicate that the modules have communication connections therebetween, which may be implemented as one or more communication buses or signal lines.

Based on the above description of the implementation methods, a person skilled in the art can understand that the present disclosure may be implemented by using software in combination with necessary general-purpose hardware, and may also be implemented by using dedicated hardware, including a dedicated integrated circuit, a dedicated CPU, dedicated memory, dedicated components, and the like. In general, functions performed by computer programs may readily be implemented using corresponding hardware, and a same function may be implemented using diverse hardware structures, such as analog circuitry, digital circuitry, and/or dedicated circuitry. In some embodiments, implementation using software programs may be preferred. Accordingly, technical solutions of the present disclosure may be embodied as a computer program product stored on a non-transitory computer-readable storage medium, such as a floppy disk, a USB flash drive, a mobile hard disk, ROM, RAM, a magnetic disk, an optical disc, or the like. The computer program product includes instructions that, when performed by one or more processors of a computing device (e.g., a personal computer, a training device, or a network device), cause the computing device to perform the methods described in the various embodiments of the present disclosure.

In the embodiments described above, implementations may be realized wholly or partly by software, hardware, firmware, or any combination thereof. When implemented by software, the implementations may be realized wholly or partly in a form of a computer program product.

The computer program product includes one or more computer instructions. When the computer instructions are loaded and performed on a computer, all or part of the processes or functions according to the embodiments of the present disclosure are generated. a general-purpose computer, a special-purpose computer, a computer network, or another programmable apparatus. The computer instructions may be stored in a computer-readable storage medium, or transmitted from one computer-readable storage medium to another computer-readable storage medium. For example, the computer instructions may be transmitted from a website, a computer, a training device, or a data center to another website, computer, training device, or data center via a wired manner (e.g., a coaxial cable, an optical fiber, or a digital subscriber line (DSL)) or a wireless manner (e.g., infrared, wireless, microwave, or the like). The computer-readable storage medium may be any available medium that can be stored by a computer, or a data storage device such as a training device or a data center that integrates one or more available media. The available media may include magnetic media (e.g., a floppy disk, a hard disk, or a magnetic tape), optical media (e.g., a DVD), or semiconductor media (e.g., a solid state disk (SSD)), and the like.

As disclosed, the method for information processing provided by the present disclosure at least realizes the following beneficial effects.

The method converts a description node tree of a display interface into hierarchical interface directory information in which each node is represented as a directory entry and node description text is used as entry content, thereby enabling a more intuitive and clearer textual representation of interface content, improving readability, and facilitating AI applications or models in determining interface content from the directory information so as to improve accuracy of task processing based on the display interface content. In addition, when node description text is missing, the method may determine a target interface region and generate node description text based on displayed content (e.g., via semantic recognition), while avoiding redundant generation when interface regions overlap, and may further optimize the description node tree by removing non-informative nodes (e.g., leaf nodes lacking node description text and certain intermediate nodes lacking node description text), thereby reducing redundancy and processing overhead and reducing number and depth of nodes or entries. By recording node description text and relative control coordinates, the method can accurately identify a target node and determine an actual control position for simulating historical control operations even when the interface is updated or refactored, thereby improving accuracy of operation replay or simulation.

What is claimed is:

1. A method for information processing, comprising:
determining, based on control node information of a target control operation and display interface description information of a display interface, a target node in the display interface that matches the control node information in response to an instruction to perform the target control operation; and
simulating, based on control information of the target control operation, a control operation on a target interface element corresponding to the target node in the display interface.

2. The method according to claim 1, wherein simulating, based on the control information of the target control operation, the control operation on the target interface element corresponding to the target node in the display interface includes:
determining a target interface region in the display interface that corresponds to the target interface element represented by the target node;
determining, based on relative control coordinates recorded in control information of the target control operation, a relative control position of the target control operation with respect to the target interface region; and
simulating the target control operation at the relative control position in the display interface.

3. The method according to claim 1, wherein being in response to the instruction to perform the target control operation includes:
responding to an instruction to perform an operation sequence, determining a target control operation to be currently simulated in the operation sequence, wherein the operation sequence includes a plurality of control operations, and the target control operation is one of the plurality of control operations.

4. The method according to claim 1, wherein determining, based on the control node information of the target control operation and the display interface description information of the display interface, the target node in the display interface that matches the control node information includes:
determining, if based on the display interface description information of the display interface, whether a unique node exists in the display interface whose node description text corresponding to a directory entry matches the control node information of the target control operation, determining the unique node as a target node; or
determining, if based on operation interface description information of the display interface, a plurality of candidate nodes in the display interface whose node description text corresponding to a directory entry matches the control node information of the target control operation, determining, from the plurality of candidate nodes, the target node having a highest matching degree with the control node information based on operation interface description information of the target control operation.

5. The method according to claim 3, wherein being in response to the instruction to perform the operation sequence includes:
responding to an operation instruction input by a user, and determining, from a set of operation sequences, an operation sequence that matches the operation instruction.

6. The method according to claim 5, further comprising:
constructing, based on a knowledge graph, an operation sequence corresponding to the operation instruction if no operation sequence matching the operation instruction exists in the set of operation sequences, the knowledge graph including relationships among a plurality of entity nodes, and an entity node representing an operating interface or a controllable functional element within the operating interface.

7. The method according to claim 1, wherein:
the display interface description information includes interface directory information, a directory entry in the interface directory information corresponding to a node in the display interface, and content of the directory entry being node description text of the node in the directory entry corresponding to the directory entry.

8. A method for processing information, comprising:
obtaining, in response to an instruction for obtaining display interface description information, a description node tree corresponding to a current display interface, the description node tree including at least one node representing interface elements on the display interface, and hierarchical relationships among different nodes, and different nodes corresponding to different interface elements;
generating, based on the hierarchical relationships among a plurality of nodes in the description node tree, interface directory information representing the current display interface by using each node in the description node tree as a directory entry and using node description text of the node as content of the directory entry; and
providing the interface directory information.

9. The method according to claim 8, before generating the interface directory information, further comprising:
determining a target interface region in the display interface associated with an interface element represented by a node if the node in the description node tree satisfies a target condition, and generating node description text for the node based on the display content within the target interface region to update the description node tree, wherein
the node satisfying the target condition includes that the node does not contain node description text for describing the interface element represented by the node.

10. The method according to claim 9, wherein the node satisfying the target condition further includes that the target interface region corresponding to the node does not overlap interface regions corresponding to other nodes that include node description text, and the interface regions corresponding to the other nodes are regions of interface elements represented by the other nodes in the display interface.

11. The method according to claim 10, further comprising:
removing nodes from the updated description node tree that satisfy a deletion condition,
the nodes satisfying the deletion condition including at least one of:
a leaf node that does not include node description text; and
a node whose parent node has only the node as a child, the node has only one child node, and the node does not include node description text.

12. An electronic device, comprising:
one or more processors and a memory containing computer programs that, when being executed, cause the one or more processors to perform a method for information processing by preforming:
determining, based on control node information of a target control operation and display interface description information of a display interface, a target node in the display interface that matches the control node information in response to an instruction to perform the target control operation; and
simulating, based on control information of the target control operation, a control operation on a target interface element corresponding to the target node in the display interface.

13. The device according to claim 12, wherein the one or more processors are further configured to perform:
determining a target interface region in the display interface that corresponds to the target interface element represented by the target node;
determining, based on relative control coordinates recorded in control information of the target control operation, a relative control position of the target control operation with respect to the target interface region; and
simulating the target control operation at the relative control position in the display interface.

14. The device according to claim 12, wherein the one or more processors are further configured to perform:
responding to an instruction to perform an operation sequence, determining a target control operation to be currently simulated in the operation sequence, the operation sequence including a plurality of control operations, and the target control operation being one of the plurality of control operations.

15. The device according to claim 12, wherein the one or more processors are further configured to perform:
determining, if based on the display interface description information of the display interface, whether a unique node exists in the display interface whose node description text corresponding to a directory entry matches the control node information of the target control operation, determining the unique node as a target node; and
determining, if based on operation interface description information of the display interface, a plurality of candidate nodes in the display interface whose node description text corresponding to a directory entry matches the control node information of the target control operation, determining, from the plurality of candidate nodes, the target node having a highest matching degree with the control node information based on operation interface description information of the target control operation.

16. The device according to claim 14, wherein the one or more processors are further configured to perform:
responding to an operation instruction input by a user, and determining, from a set of recorded operation sequences, an operation sequence that matches the operation instruction.

17. The device according to claim 16, wherein the one or more processors are further configured to perform:
constructing, based on a knowledge graph, an operation sequence corresponding to the operation instruction if no operation sequence matching the operation instruction exists in a set of operation sequences, the knowledge graph including relationships among a plurality of entity nodes, and an entity node representing an operating interface or a controllable functional element within the operating interface.

18. An electronic device, comprising:
one or more processors and a memory containing computer programs that, when being executed, cause the one or more processors to perform the method for processing information according to claim 8.

19. The device according to claim 18, wherein the one or more processors are further configured to perform:
determining a target interface region in the display interface associated with an interface element represented by a node if the node in the description node tree satisfies a target condition, and generating node description text for the node based on the display content within the target interface region to update the description node tree, wherein
the node satisfying the target condition includes that the node does not contain node description text for describing the interface element represented by the node.

20. The device according to claim 19, wherein the node satisfying the target condition further includes that the target interface region corresponding to the node does not overlap interface regions corresponding to other nodes that include node description text, and the interface regions corresponding to the other nodes are regions of interface elements represented by the other nodes in the display interface.
